(19) United States
(12) Patent Application Publication
(10) Pub. No.: US 2012/0048893 A1
(43) Pub. Date: Mar. 1, 2012

(54) DISPENSER AND STABILISER THEREFOR

(76) Inventor: Clifford Edward Beckett, Berkshire (GB)

(21) Appl. No.: 13/116,859

(22) Filed: May 26, 2011

(30) Foreign Application Priority Data
Aug. 24, 2010 (DE) DE 202010 011769

(51) Int. Cl. B65D 88/54; G01F 11/00

(52) U.S. Cl. 222/326; 222/333; 222/390

(57) ABSTRACT

A stabilising arrangement to limit the transverse movement of a shaft inside a hollow tube. The stabilising arrangement can include a plurality of stabilizing members each defining a bore for accepting the shaft therethrough and a portion extending outwards from the bore to limit transverse movement of the shaft inside the hollow tube. One or more respective resiliently deformable spacers or springs can be attached to and positioned between the stabilising members to resiliently space the stabilizing members apart, while allowing the stabilizing members to be compressed together or expanded inside the hollow tube.

### RELATED APPLICATIONS

This application is related to German Gebrauchsmuster DE 20 2010 011 769, filed Aug. 24, 2010, and U.S. patent application Ser. No. 13/014,331, filed Jan. 26, 2011, each of which is incorporated by reference herein.

### FIELD OF THE INVENTION

The present invention relates to dispensers, in particular dispensers for viscous materials, and to a drive member for applying a dispensing pressure to the material.

### BACKGROUND OF THE INVENTION

Dispensers for materials such as viscous materials, for example caulk or adhesive, comprise a body portion and a holder for holding the material relative to the body portion such that a drive mechanism can exert a dispensing pressure on the material. The material may be held in bulk directly by the holder or the holder may be arranged to accept a container such as a foil pack so that the drive mechanism exerts the dispensing pressure on the material via the container. One particular container comprises a cartridge having a barrel for accepting the material to be dispensed from one end of the barrel and having a piston sealing the other end of the barrel so that the drive mechanism applies the dispensing pressure to the piston. The body portion typically houses the drive mechanism and is shaped to provide a handle and a trigger arrangement for actuating the drive mechanism.

The drive mechanism typically comprises a push rod or similar drive member for exerting the dispensing pressure on the material, either by pushing directly onto the material or by pushing on the container, the foil pack or the piston of the cartridge, as the case may be. One particular drive mechanism includes a reciprocating plate, accepting the push rod, actuated by a trigger lever. Repeated actuation of the trigger lever results in the catch plate biting on the push rod to advance the push rod with each stroke of the trigger lever and to slide backwards over the push rod when the trigger lever is released with the push rod being held in its advanced position by a braking arrangement. An alternative drive mechanism comprises an electric motor driving the push rod, for example by driving a gear which engages a toothed surface of the push rod.

The volume of material which can be held by the dispenser depends on the longitudinal and transversal dimensions of the holder (where the material is held in bulk or in a non-rigid foil pack which needs to be enclosed by the holder) or the cartridge. In applications where large volumes of material need to be dispensed, it may be desirable to design the dispenser (or cartridge) with a form factor in which the cartridge or holder is significantly longer than it is wide. Also, in some applications it may be desirable that a dispensing end of the dispenser is spaced a significant distance away from the handle of the dispenser. As a result of the elongated form factor of such designs, the total dispensing stroke of the push rod has to be of corresponding length.

### SUMMARY OF THE INVENTION

In dispensers where the lengths of the dispensing stroke (and hence the length of the push rod) is extended beyond lengths typical for known caulk or adhesive dispensers, the length of the push rod between an end of the push rod applying the dispensing force and the drive mechanism, as the push rod is advanced, means that the push rod is prone to buckling and bending under the dispensing force, reducing dispensing efficiency and smooth operation of the dispenser.

In one embodiment of the invention, there is provided a dispenser for dispensing a material. The dispenser can comprise a body portion, which includes a drive mechanism, and a holder for holding the material relative to the drive mechanism. A drive member can be coupled to the drive mechanism to be longitudinally driveable relative to the holder to apply a dispensing pressure to the material. The dispenser further comprises a stabilising member slidable along the drive member relative to the holder. The stabilising member extends transversally away from the drive member to limit transverse movement of the drive member relative to the holder. A resiliently deformable positioning member positions the stabilising member along the drive member.

In one embodiment, the stabilising member extending transversally away from the drive member limits transverse movement of the drive member because, as the drive member buckles or bends as a result of the dispensing pressure, the stabilising member engages an inner wall of the holder (or an inner wall of a cartridge held by the holder) to substantially prevent further transverse movement of the drive member relative to the holder. The stabilising member can be slideable along the length of drive member, and therefore not interfere with the drive member being fully retracted towards the drive mechanism to allow the holder to accept the material (whether in the form of bulk material, a container such as a foil pack or in a cartridge). The resiliently deformable positioning member ensures that the stabilising member is positioned in an appropriate supporting location as the drive member is advanced to dispense the material without interfering with the retraction of the drive member. When the drive member is fully retracted, the resiliently deformable positioning member deforms to allow the drive member to be retracted. When the drive member is fully advanced, the stabilising member is positioned in an appropriate support position, where buckling or bending can occur, along the drive member by the positioning member.

In one embodiment, the resiliently deformable positioning member can be disposed between the stabilising member and an end of the drive member. The stabilising member can be secured by the resiliently deformable positioning member to the drive member in an embodiment.

In one embodiment, the resiliently deformable positioning member is disposed between the stabilising member and the body portion. In one embodiment the stabilising member is secured by the resiliently deformable positioning member to the holder (either by direct attachment to the holder or by attachment to the body portion). In one embodiment, the resiliently deformable positioning member is disposed between the stabilising member and a further stabilising member. In one embodiment the stabilising member is secured by the resiliently deformable positioning member to the further stabilising member. The stabilising member or members are positioned along the drive member, away from the end of the drive member and the body portion to support the drive member at one or more points where buckling or bending can occur. In embodiments in which the positioning members secure the stabilising members, depending on the rest configuration of the positioning members the stabilising members are positioned by a combination of pushing and pulling, or pulling or pushing alone, by the positioning member or members. In embodiments in which the positioning members are merely interspersed between the stabilising member or members and the body portion or the end of the drive member and/or between stabilising members as applicable, the stabilising members are positioned by virtue of pushing forces alone.

In one embodiment, the resiliently deformable positioning member comprises a coiled spring disposed around the drive member. The drive member can include a rod or a toothed rod, for example for driving by a transmission gear of an electric drive. The stabilising member, can comprise a sleeve slideably disposed around the drive member and, in some embodiments, a portion extending transversally from the sleeve to limit transverse movement of the drive member relative to the holder.

In one embodiment, the stabilising member can define one or more contact surfaces for exerting a contact force to limit transverse movement of the drive member relative to the holder, the one or more contact surfaces can span an angle of 180 degrees or more around the drive member. For example, in an embodiment, the stabilising member comprises a transversally extending portion having a disk shaped transverse cross section. In an embodiment in which the holder comprises a barrel for accepting the material, the stabilising member can have a sliding fit within the barrel.

Since, in some embodiments, the stabilising member is an easy sliding fit both with the drive member and (where applicable) the barrel, the transverse movement by the drive member is limited, rather than eliminated, and will depend on the clearance between the stabilising member and the drive member and between the stabilising member and the barrel. In one embodiment, the clearance between the stabilising member and one or both of the drive member and the barrel can be approximately 1 mm.

In another embodiment, a dispenser as described above is provided, can include a plurality of stabilising members disposed slideably along the drive member relative to the holder and extending transversally away from the drive member to limit transverse movement of the drive member relative to the holder. Respective resiliently deformable positioning members position the plurality of stabilising members apart from each other, an end of the drive member, and the body portion.

In one embodiment, the stabilising members define a plurality of contact surfaces for exerting a contact force to limit transverse movement of the drive member relative to the holder, the contact surfaces spanning an angle of 180° or more around the drive member. The stabilising members may either each have one or more contact surfaces spanning 180° or more or the contact surfaces of all stabilising members may collectively span this angle. By spanning an angle of 180° or more around the drive member, the contact surfaces, stabilise the drive member, at least to some extent, in all directions. Naturally, the higher the angle spanned, the better the mechanical stability and in various embodiments, the contact surfaces can span an angle of 360°. Similarly, the more continuous the contact surfaces are, the better the mechanical load is spread. Accordingly, in one embodiment, the stabilising member or members can have a disk shaped transverse cross section defining a continuous contact surface spanning 360 degrees. In one embodiment, the resiliently deformable positioning members can be arranged to space the stabilising members evenly along the drive member, again distributing the load associated with limiting transverse movement of the drive member. In one embodiment, the positioning members can be arranged to position the stabilising members by pulling on the stabilising members.

In yet another embodiment, a stabilising arrangement can be included to limit the transverse movement of a longitudinally elongate member inside a hollow member. For example, the longitudinally elongate member can be a drive member of a dispenser as described above and the hollow member can be a material accepting barrel of a material holder or cartridge. The stabilising arrangement can comprises a plurality of stabilising members each defining a bore for accepting the longitudinally elongate member therethrough and included a portion extending outwards from the bore to limit transverse movement of the longitudinally elongate member inside the hollow member. The stabilising arrangement further comprises one or more respective resiliently deformable positioning members disposed between the stabilising members to resiliently position the stabilising members relative to each other. In one embodiment, the positioning members are arranged to position the stabilising members by pulling on the stabilising members.

### BRIEF DESCRIPTION OF THE DRAWINGS

The embodiments of the present invention may be more completely understood in consideration of the following specific embodiment, now described as an example by way of illustration and not limitation, with reference to the accompanying drawings in which:

FIG. 1 is a side elevation view of a dispenser with a drive member fully retracted, including a partial sectional view revealing a stabilising arrangement in a compressed configuration.

FIG. 2 is a side elevation view of the dispenser with the drive member fully advanced, including a partial sectional view revealing the stabilising arrangement in an extended configuration.

FIG. 3 is a detailed view of a portion of FIGS. 1 and 2 depicting a stabilising member of the stabilising arrangement.

FIG. 4A is a front view of the stabilising member of FIG. 3.

FIGS. 4B through 4O schematically illustrate various embodiments of stabilising members.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

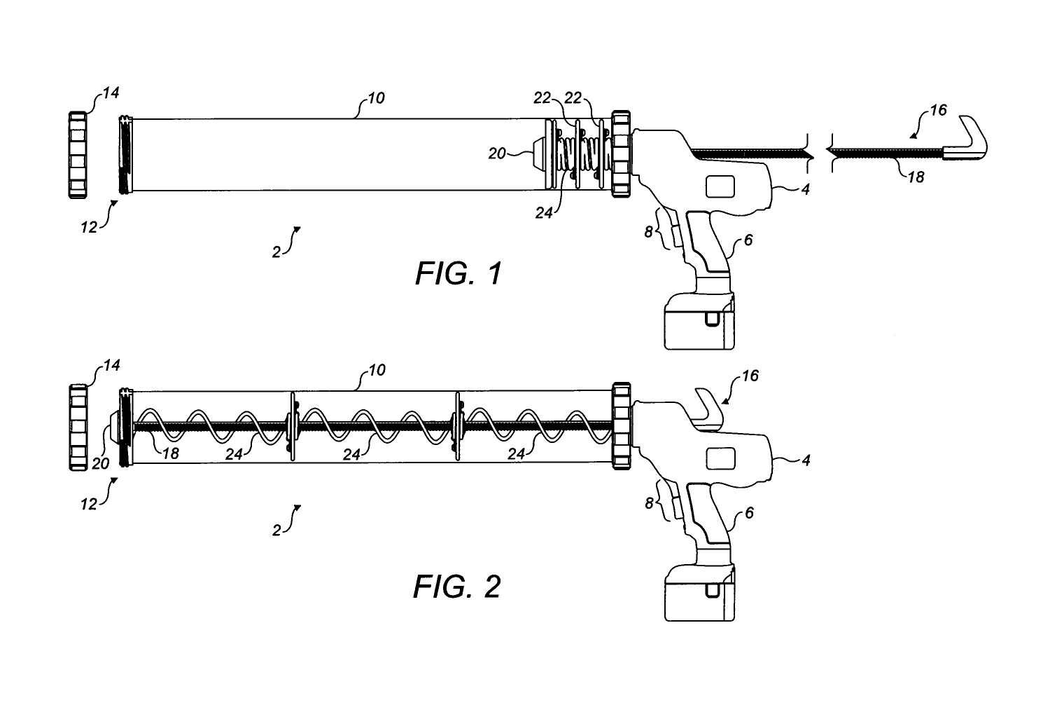

With reference to FIGS. 1 and 2, a dispenser 2 for viscous or similar materials includes a body portion 4 housing an electrically powered drive mechanism. The body portion 4 is shaped to define a handle 6 to be held in the hand of an operator, and a trigger arrangement 8 for actuating the drive mechanism. A battery pack for powering the drive mechanism can be attached to the handle 6.

A cylindrical tube 10 for holding a foil pack or other material container is coupled to and extends forward of the body portion 4. The tube 10 is secured to the body portion 4 at one end and has an opposed open end 12 to accept a foil pack or a material cartridge. The open end 12 is arranged to accept a collar 14 with a threaded connection to secure the foil pack or cartridge inside the tube 10 with a dispensing nozzle of the foil pack extending through the collar 14.

A drive rod 16 can extend through the body portion 4 into the tube 10. The drive rod 16 includes opposed toothed surfaces 18 to engage with respective gears of the drive mechanism in order to actuate the drive rod 16. The drive rod 16 can be advanced towards the open end 12 of the tube 10 and retracted in the opposite direction by a corresponding actuation of the trigger arrangement 8. At a forward end of the drive rod 16 a plunger 20 is secured to the drive rod 16 to exert a dispensing pressure onto the foil pack to dispense the viscous material as the drive rod 16 is advanced. The drive rod 16 is illustrated fully retracted in FIG. 1 and fully advanced in FIG. 2.

Stabilising members 22 are slideably carried on the drive rod 16 inside the tube 10 and are sized to have a sliding clearance fit inside the tube 10. The stabilising members 22 can be manufactured from any suitable polymer, metal or a combination thereof. For example stabilising members 22 can be manufactured by moulding Nylon or ABS plastic. Respective springs 24, each comprising coiled Nylon tubing, are disposed around the drive rod 16 forward of the stabilising members 22 between the stabilising members 22 and the plunger 20, rearward of the stabilising members 22 between the stabilising members 22 and the body portion 4, and between the stabilising members 22. The spring 24 forward of the stabilising members 22 is secured to the plunger 20 and to the stabilising members 22 adjacent to it. The springs 24 rearward of the stabilising members 22 is secured to the body portion 4 (and hence the tube 10 secured to the body portion 4) and the stabilising member 22 adjacent to it. The spring 24 between the stabilising members 22 is secured to each stabilising member 22 adjacent to it.

The springs 24 can have a rest length such that they are elongated relative to their rest length when the rod is fully advanced and compressed, or bunched up, when the rod is fully retracted. When the drive rod 16 is retracted, the stabilising members 22 slide together so that the drive rod 16 can be retracted. When the drive rod 16 is advanced the stabilising members 22 are first pushed and then pulled apart by the springs 24 so that they are evenly positioned along the drive rod 16. In this way, as the drive rod 16 advances, the stabilising members 22 are positioned along the drive rod 16 where buckling or bending is likely to occur. The positioning of the stabilising members 22 is readily adjusted by selecting springs of appropriate rest length and spring constants (or more generally springiness).

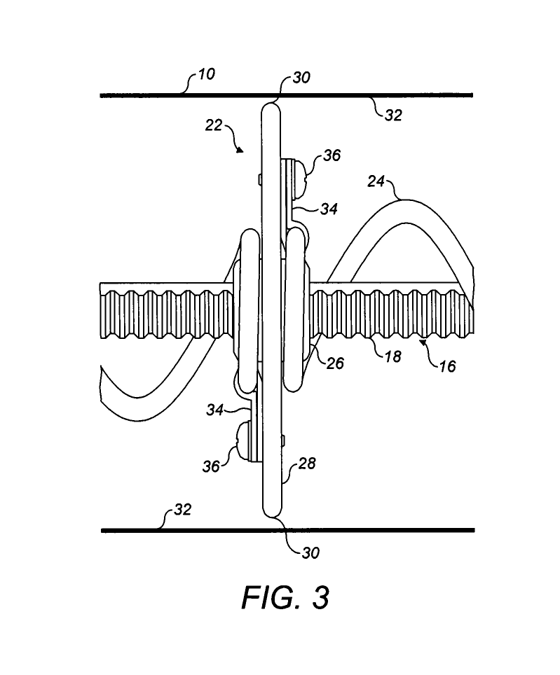

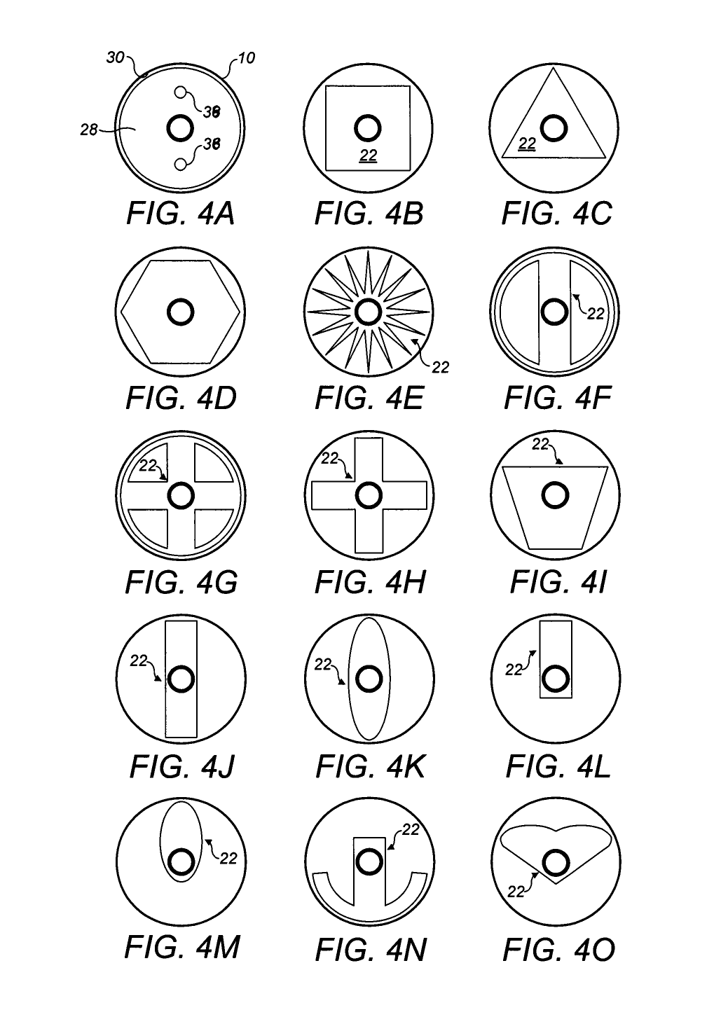

With reference to FIGS. 3 and 4a, the stabilising members 22 can each include a sleeve 26 disposed around the drive rod 16, and a disc 28 extending away from the sleeve 26. The perimeter of the disk provides a contact surface 30 for contacting an inner wall 32 of the tube 10 as the drive member buckles or bends, thereby exerting a reaction force on the drive rod 16 to substantially prevent (subject to material deformation) further buckling or bending. The stabilising member 22 thus limits buckling or bending of the drive rod 16. In order to easily slide relative to the drive rod 16 and the tube 10, the sleeve 26 includes a clearance fit with the drive rod 16, and the disc 28 includes a clearance fit with the tube 10. Both clearances can be approximately 1 mm. Since the shape of the contact surfaces 30 conforms to the shape of the inner wall 30, the limit on buckling and bending is uniform around the drive rod 10.

The springs 24 can be attached to the stabilising members 22 by pipe clips 34 secured to the disc 28 by respective screws 36. The pipe clips 34 can be of conventional construction having a substantially tubular portion of an inner diameter smaller than the outer diameter of the Nylon tubing of the springs 24, and include flanges on either side of a slit in the substantially tubular portion to compress the substantially tubular portion around the nylon tubing. The pipe clips 34 can be secured to the disc 28 by the screws 36 through holes in the flanges to threaded holes 38 in the disc 28. Alternative mechanisms for attaching the springs 24 to the stabilising members 22 are also contemplated.

The above description of a specific embodiment of the invention has been made for the purpose of illustration, by way of example and not limitation. Numerous modifications, alterations and juxtaposition are possible and intended to be within the scope of the present invention. Some such modifications, alterations and juxtapositions are now described but others will readily occur to a person skilled in the art.

FIGS. 4B through 4O illustrate alternative embodiments for the stabilising members 22, having varying shapes for the portion extending from the sleeve 26 instead of a disc 28. FIGS. 4B to 4D, 4F, 4G and 4I to 4N illustrate continuous contact surfaces 30 with FIGS. 4E, 4H and 4O illustrating discontinuous contact surfaces 30. The contact surfaces 30 of FIGS. 4B to 4K span 180° or more around the drive rod 16, with FIGS. 4B to 4H spanning 360° around the drive rod 16.

FIGS. 4L to 4O illustrate contact surfaces 30 spanning less than 180° around the drive rod 16. Individually, these contact surfaces 30 do not limit buckling or bending (at least to the extent likely to be encountered during normal operation) in all directions around the drive rod 16. However, in some embodiments where a plurality of stabilising members 22 with such contact surfaces 30 are arranged along the drive rod 16, rotated relative to each other such that collectively (in projection) an angle of 180° or more is spanned around the drive member, overall movement of the drive rod 16 can be limited in all directions.

In one embodiment the stabilising member 22, rather than being arranged as a sleeve 26 with a protruding portion carrying the contact surface 30, can be arranged to be of substantially uniform thickness. In other embodiments the thickness varies with radial position, either decreasing or increasing from the drive rod 16.

The number and configuration of springs 24 and stabilising members 22 can vary in different embodiments. In one embodiment, a single stabilising member 22 is secured to either the plunger 20 or body portion 4. The position of stabilising member 22 along the drive rod 16 is defined by the rest length of the spring 24 securing it, once the drive rod 16 is advanced beyond this length. In one embodiment a single stabilising member 22 has a spring 24 on each side, each of which can be secured to, respectively, the plunger 20 and body portion 4.

In embodiments with more than one stabilising member 22, the springs 24 are merely interspersed between the stabilising members 22, plunger 20, and body portion 4. In embodiments where the stabilising member 22 or members are not secured by the springs 24, the stabilising members 22 are positioned by a pushing action of the springs 24 alone. In embodiments where the springs 24 are attached to one or more of the stabilising member(s), the plunger 20 and body portion 4, one or both of pushing and pulling forces can act to position the stabilising member(s) along the length of the drive rod 16 depending on the rest lengths of the springs 24 in each embodiment.

Any suitable resilient material, including suitable polymers (in tubing or filled form) or metals can be used for the springs 24 in place of the Nylon tubing in some embodiments. Other arrangements providing resilient positioning members are equally envisaged, for example a plurality of springs arranged around the drive rod 16, springs other than coiled springs and any resilient members capable of positioning the stabilising members 22.

In place of a tube 10 for accommodating a foil pack, other holders for holding the material to be dispensed relative to the drive mechanism are used in some embodiments, for example any holder which can support a foil pack when a dispensing pressure is applied to it, or a holder for holding a material containing cartridge relative to the drive mechanism. In the latter case, the contact surfaces 30 contact the inner wall 32 of the cartridge to limit bending or buckling. More than one holder for a corresponding number of foil packs or cartridges or a holder adapted for a multibarrel cartridge may be provided in some embodiments, together with a corresponding number of plungers, rods and stabilising arrangements. In some embodiments, the holder is adapted to hold a material directly in bulk. The inner wall of the tube 10, other holder or cartridge, in various embodiments, has an inner wall shape which is dictated by the application in hand or varies otherwise, for example a circular oval or square cross-sectional shape. In some of these embodiments, the stabilising member, plunger or both conform to the respective cross-sectional shape to provide substantially uniform limits on buckling or bending.

The application of the disclosed stabilising arrangement is not limited to electrically driven dispensers with toothed drive rods, but the dispenser 2 can employ any suitable drive mechanism, for example a plate and trigger mechanism as described above (with a corresponding rod lacking teeth). Equally, the applications are not limited to hand held dispensers.

Finally, it will be understood that many suitable materials and manufacturing techniques can be used in various embodiments and that any dimensions, and in particular clearances related to the stabilising members 22 vary according to the needs of the specific applications of the numerous possible embodiments.

For purposes of interpreting the claims for the present invention, it is expressly intended that the provisions of Section 112, sixth paragraph of 35 U.S.C. are not to be invoked with respect to a given claim unless the specific terms “means for” or “step for” are recited in that claim.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A dispenser for dispensing a material, the dispenser comprising:
a body portion comprising a drive mechanism;
a holder for holding the material relative to the drive mechanism;
a drive member coupled to the drive mechanism to be longitudinally driveable relative to the holder to apply a dispensing pressure to the material;
a stabilising member slideable along the drive member relative to the holder and extending transversely away from the drive member to limit transverse movement of the drive member relative to the holder; and
a resiliently deformable positioning member for positioning the stabilising member along the drive member.

2. A dispenser as claimed in claim 1 in which the resiliently deformable positioning member is disposed between the stabilising member and an end of the drive member.

3. A dispenser as claimed in claim 2, in which the stabilising member is secured by the resiliently deformable positioning member to the drive member.

4. A dispenser as claimed in claim 1 in which the resiliently deformable positioning member is disposed between the stabilising member and the body portion.

5. A dispenser as claimed in claim 4 in which the stabilising member is secured by the resiliently deformable positioning member to the body portion.

6. A dispenser as claimed in claim 1 in which the resiliently deformable positioning member is disposed between the stabilising member and a further stabilising member slideable along the drive member and extending transversely away from the drive member to limit transverse movement of the drive member relative to the holder.

7. A dispenser as claimed in claim 6 in which the stabilising member is secured by the resiliently deformable positioning member to the further stabilising member.

8. A dispenser as claimed in claim 1 in which the resiliently deformable positioning member comprises a coiled spring disposed around the drive member.

9. A dispenser as claimed in claim 1 in which the drive member comprises a rod.

10. A dispenser as claimed in claim 1 in which the drive member comprises a toothed rod.

11. A dispenser as claimed in claim 1 in which the stabilising member comprises a sleeve slideably disposed around the drive member.

12. A dispenser as claimed in claim 11 in which the stabilising member comprises a spacer portion extending transversely from the sleeve to limit transverse movement of the drive member relative to the holder.

13. A dispenser as claimed in claim 1 in which the stabilising member defines one or more contact surfaces for exerting a contact force to limit transverse movement of the drive member relative to the holder, the one or more contact surfaces spanning an angle of 180° or more around the drive member.

14. A dispenser as claimed in claim 1 in which the stabilising member comprises a portion having a disc-shaped transverse cross-section.

15. A dispenser as claimed in claim 1 in which the holder comprises a tube for accepting the material, the stabilising member being a sliding fit within the tube.

16. A dispenser for dispensing a material, the dispenser comprising:
a body portion comprising a drive mechanism;
a holder for holding the material relative to the drive mechanism;
a drive member coupled to the drive mechanism to be longitudinally driveable relative to the holder to apply a dispensing pressure to the container;
a plurality of stabilising members slideable along the drive member relative to the holder and extending transversely away from the drive member to limit transverse movement of the drive member relative to the holder; and
respective resiliently deformable positioning members for spacing the plurality of stabilising members from each other, an end of the drive member and the body portion.

17. A dispenser as claimed in claim 16 in which the stabilising members define a plurality of contact surfaces for exerting a contact force to limit transverse movement of the drive member relative to the holder, the contact surfaces spanning an angle of 180° or more around the drive member.

18. A dispenser as claimed in claim 16 in which the resiliently deformable positioning members are arranged to space the stabilising members evenly along the drive member.

19. A dispenser as claimed in claim 15 in which the holder comprises a tube for accepting the material, the stabilising member being a sliding fit within the tube.

20. A dispenser as claimed in claim 16 in which the resiliently deformable positioning members are arranged to space the stabilising members from each other, the end of the drive member and the body portion by pulling on the stabilising members.

21. A stabilising arrangement for limiting transverse movement of a longitudinally elongate member inside a hollow member, the arrangement comprising:
a plurality of stabilising members each defining a bore for accepting the longitudinally elongate member therethrough and comprising a portion extending outwards from the bore to limit transverse movement of the longitudinally elongate member inside the hollow member; and
one or more respective resiliently deformable spacers disposed between the stabilising members to resiliently space the stabilising members apart.
